(19) United States
(12) Patent Application Publication
(10) Pub. No.: US 2013/0292614 A1
(43) Pub. Date: Nov. 7, 2013

(54) FLUORINATED OXIRANES AS DIELECTRIC FLUIDS

(71) Applicants: Phillip E. Tuma, Faribault, MN (US); Richard M. Minday, Stillwater, MN (US); Zhongxing Zhang, Woodbury, MN (US); Michael G. Costello, Afton, MN (US); Richard M. Flynn, Mahtomedi, MN (US); John G. Owens, Woodbury, MN (US); Michael J. Bulinski, Houlton, WI (US)

(72) Inventors: Phillip E. Tuma, Faribault, MN (US); Richard M. Minday, Stillwater, MN (US); Zhongxing Zhang, Woodbury, MN (US); Michael G. Costello, Afton, MN (US); Richard M. Flynn, Mahtomedi, MN (US); John G. Owens, Woodbury, MN (US); Michael J. Bulinski, Houlton, WI (US)

(73) Assignee: 3M INNOVATIVE PROPERTIES COMPANY, St. Paul, MN (US)

(21) Appl. No.: 13/997,387

(22) PCT Filed: Jan. 18, 2012
(86) PCT No.: PCT/US12/21628

§ 371 Date: Jun. 24, 2013

Related U.S. Application Data
(60) Provisional application No. 61/435,867, filed on Jan. 25, 2011.

(51) Int. Cl. H01B 3/24; H01B 3/56

(52) U.S. Cl. CPC H01B 3/24; H01B 3/56
USPC 252/571; 549/550

(57) ABSTRACT

An electrical device containing as a component a C₃ to C₁₅ fluorooxirane fluid dielectric is provided.

### CROSS REFERENCE TO RELATED APPLICATION

This application claims the benefit of U.S. Provisional Patent Application No. 61/435,867, filed Jan. 25, 2011, the disclosure of which is incorporated by reference herein in its entirety.

### FIELD OF THE INVENTION

This invention relates to fluorinated oxiranes (fluorooxiranes) and the use thereof as dielectric fluids in electrical devices such as capacitors, switchgear, transformers and electric cables or buses.

### BACKGROUND

Dielectric gases are used in various electrical apparatus; see for example U.S. Pat. No. 7,807,074 (Luly et al.). Major types of such apparatus are transformers, electric cables or buses, and circuit breakers or switchgear. In such electrical devices, dielectric gases are often used in place of air due to their high dielectric strength (DS). Such dielectric gases allow higher power densities as compared to air-filled electrical devices.

Most significantly sulfur hexafluoride (SF₆) has become the dominant captive dielectric gas in many electrical applications. SF₆ is advantageously nontoxic, non-flammable, easy to handle, has a useful operating temperature range, and excellent dielectric and arc-interrupting properties. Within transformers, it also acts as a coolant. Blowers within the transformer often circulate the gas aiding in heat transfer from the windings.

However, the greatest concern with SF₆ is its 3200 year atmospheric lifetime and very significant global warming potential (GWP) of about 22,200 times the global warming potential of carbon dioxide. At the December 1997 Kyoto Summit in Japan, representatives from 160 countries drafted an agreement containing limits for greenhouse gas emissions. The agreement covers six gases, including SF₆, and included a commitment to lower the total emissions of these gases by the year 2010 to levels 5.2% below their total emissions in 1990. See UNEP (United Nations Environment Programme), Kyoto Protocol to the United Nations Framework Convention on Climate Change, Nairobi, Kenya, 1997.

The National Institute of Standards and Technology (NIST) have published Technical Note 1425: “Gases for electrical Insulation and Arc Interruption: Possible Present and Future Alternatives to Pure SF₆”, which identifies, as possible replacements, mixtures of SF₆ with either nitrogen or helium, or high-pressure nitrogen. Some other replacement mixtures suffer from release of free carbon during arcing, increased toxicity during or after arcing, and increased difficulty in gas handling during storage, recovery and recycling. Also identified are perfluorocarbon (PFC) gases that might also be mixed with nitrogen or helium, like SF₆. Yet PFCs also have high GWPs so the possible reduction in environmental impact of such strategies is limited.

### SUMMARY

Briefly, the present disclosure provides a dielectric fluid comprising one or more fluorooxiranes of the formula:

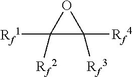

wherein each of R_{f}¹, R_{f}², R_{f}³ and R_{f}⁴ are selected from a hydrogen atom, a fluorine atom or a fluoroalkyl group, preferably a fluorine atom or a perfluoroalkyl group, and the sum of the carbon atoms of said perfluorooxiranes is 3 to 15. In some embodiments any two of said R_{f} groups may be joined together to form a fluorocycloalkyl ring, preferably a perfluorocycloalkyl ring. C₄-C₁₅ fluoroxiranes have 2 or fewer hydrogen atoms, preferably zero hydrogen atoms. The C₃ fluorooxirane contains 1 or 2 hydrogen atoms. Optionally R_{f}¹ to R_{f}⁴ contain one or more catenary (in-chain) heteroatoms, such as divalent oxygen or trivalent nitrogen bonded only to carbon atoms, such heteroatoms being a chemically stable link between perfluorocarbon portions of the perfluoroaliphatic group and which do not interfere with the inert character of the perfluoroaliphatic group. In preferred embodiments, R_{f}¹ to R_{f}⁴ are fluorine atoms or perfluoroalkyl groups. The skeletal chain of R_{f}¹ to R_{f}⁴ can be straight chain, branched chain, and if sufficiently large, cyclic, such as fluorocycloaliphatic groups. In some embodiments at least one of R_{f}¹ to R_{f}⁴ is a branched perfluoraliphatic group.

In this application the term “dielectric fluid” is inclusive of both liquid dielectrics and gaseous dielectrics. The physical state of the fluid, gaseous or liquid, is determined at the operating conditions of temperature and pressure of the electrical device in which it is used.

In electrical devices such as capacitors, dielectric liquids are often used in place of air due to their low dielectric constant (K) and high dielectric strength (DS). Some capacitors of this type comprise alternate layers of metal foil conductors and solid dielectric sheets of paper or polymer film. Other capacitors are constructed by wrapping the metal foil conductor(s) and dielectric film(s) concentrically around a central core. This latter type of capacitor is referred to as a “film-wound” capacitor. Dielectric liquids are often used to impregnate dielectric film due to their low dielectric constant and high dielectric strength. Such dielectric liquids allow more energy to be stored within the capacitor (higher capacitance) as compared to air- or other gas-filled electrical devices.

In some embodiments the fluoroxirane is a gaseous dielectric at the operating conditions of the device. The gaseous dielectric may be useful in a number of other applications that use dielectric gases. Examples of such other applications are described in the aforementioned NIST technical note 1425. The disclosure further provides an electrical device containing as a component the fluorooxirane gaseous dielectric. In some embodiments, the present disclosure further provides a gaseous dielectric comprising a mixture of a fluorooxirane and an inert gas, such as nitrogen.

Fluorooxiranes as a dielectric fluids advantageously have a broad range of operating temperatures and pressures, are thermally, and chemically stable, have a higher dielectric strength and heat transfer efficiency than SF₆ at a given partial pressure, and has a lower global warming potential (GWP) than SF₆. The instant fluorooxiranes generally have a dielectric strength greater than 5 kV at a pressure of 20 kPa at the operating temperature of the electrical device.

In the present disclosure:

“fluorinated” refers to hydrocarbon compounds that have one or more C—H bonds replaced by C—F bonds;

“fluoroalkyl has essentially the meaning as “alkyl” except that one or more of the hydrogen atoms of the alkyl radical are replaced by fluorine atoms.

“fluoroalkylene has essentially the meaning as “alkylene” except that one or more of the hydrogen atoms of the alkyl radical are replaced by fluorine atoms.

“Perfluoroalkyl” has essentially the meaning as “alkyl” except that all or essentially all of the hydrogen atoms of the alkyl radical are replaced by fluorine atoms, e.g. perfluoropropyl, perfluorobutyl, perfluorooctyl, and the like.

“Perfluoroalkylene” has essentially the meaning as “alkylene” except that all or essentially all of the hydrogen atoms of the alkylene radical are replaced by fluorine atoms, e.g., perfluoropropylene, perfluorobutylene, perfluorooctylene, and the like

“Perfluorinated” or the prefix “perfluoro” means an organic group wherein all or essentially all of the carbon bonded hydrogen atoms are replaced with fluorine atoms, e.g. Perfluoroalkyl and the like.

### BRIEF DESCRIPTION OF THE FIGURES

FIG. 1 is a graph of the dielectric strength performance of the gaseous perfluorooxirane dielectrics as compared to SF₆ and other known dielectrics.

FIG. 2 is an illustration of electrical hardware using a fluorooxirane gaseous dielectric.

As used herein, “GWP” is a relative measure of the warming potential of a compound based on the structure of the compound. The GWP of a compound, as defined by the Intergovernmental Panel on Climate Change (IPCC) in 1990 and updated in 2007, is calculated as the warming due to the release of 1 kilogram of a compound relative to the warming due to the release of 1 kilogram of CO₂ over a specified integration time horizon (ITH).

$${GWP}_{i} ( {t}^{′} ) = \frac{{\int }_{0}^{ITH} {a}_{i} [ C ( t ) ] d t}{{\int }_{0}^{ITH} {a}_{{co}_{2}} [ {C}_{{co}_{2}} ( t ) ] d t} = \frac{{\int }_{0}^{ITH} {a}_{i} {C}_{oi} {e}^{- t / {τ}_{i}} d t}{{\int }_{0}^{ITH} {a}_{{co}_{2}} [ {C}_{{co}_{2}} ( t ) ] d t}$$

In this equation aᵢ is the radiative forcing per unit mass increase of a compound in the atmosphere (the change in the flux of radiation through the atmosphere due to the IR absorbance of that compound), C is the atmospheric concentration of a compound, τ is the atmospheric lifetime of a compound, t is time and i is the compound of interest.

The commonly accepted ITH is 100 years representing a compromise between short-term effects (20 years) and longer-term effects (500 years or longer). The concentration of an organic compound, i, in the atmosphere is assumed to follow pseudo first order kinetics (i.e., exponential decay). The concentration of CO₂ over that same time interval incorporates a more complex model for the exchange and removal of CO₂ from the atmosphere (the Bern carbon cycle model).

As a result of their degradation in the lower atmosphere, the fluorooxiranes have shorter lifetimes and would contribute less to global warming, as compared to SF₆. The lower GWP of the fluorooxiranes, in addition to the dielectric performance characteristics, make them well suited for use as a fluid dielectric.

Advantageously, the dielectric fluid of the present disclosure has a high electrical strength, also described as high breakdown voltage. “Breakdown voltage,” as used in this application means (at a specific frequency) the highest voltage applied to a fluid that induces catastrophic failure of the fluid dielectric allowing electrical current to conduct through the gas. Thus the fluid dielectric of the present invention can function under high voltages. The fluid dielectric can also exhibit a low loss factor, that is, the amount of electrical energy that is lost as heat from an electrical device such as a capacitor.

Perfluorooxiranes that are useful in the present invention include those oxiranes having only fluorine attached to the carbon backbone. More specifically, the instant perfluorooxiranes are of formula:

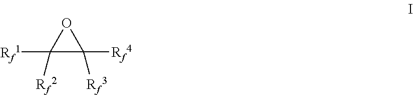

wherein each of R_{f}¹, R_{f}², R_{f}³ and R_{f}⁴ are selected from a fluorine atom or a perfluoroalkyl group, and the sum of the carbon atoms of said perfluorooxiranes is 4 to 15. In some embodiments any two of said R_{f} groups may be joined together to form a perfluorocycloalkyl ring. Optionally R_{f}¹ to R_{f}⁴ contain one or more catenary (in-chain) heteroatoms, such as divalent oxygen or trivalent nitrogen bonded only to carbon atoms, such heteroatoms being a chemically stable link between perfluorocarbon portions of the perfluoroaliphatic group and which do not interfere with the inert character of the perfluoroaliphatic group. In preferred embodiments, R_{f}¹ to R_{f}⁴ are fluorine atoms or perfluoroalkyl groups. The skeletal chain of R_{f}¹ to R_{f}⁴ can be straight chain, branched chain, and if sufficiently large, cyclic, such as fluorocycloaliphatic groups. In some embodiments at least one of R_{f}¹ to R_{f}⁴ is a branched perfluoraliphatic group.

Fluorooxiranes that are useful in the present invention also include those oxiranes having one or two hydrogen atoms attached to the carbon backbone. More specifically, useful fluorinated oxiranes are of the formula I wherein each of R_{f}¹, R_{f}², R_{f}³ and R_{f}⁴ are selected from a fluorine atom, a hydrogen atom or a fluoroalkyl group; wherein the sum of the hydrogen atoms is 1 or 2 and: wherein the sum of the carbon atoms of the fluorinated oxirane is 3 to 15.

In some embodiments any two of said R_{f} groups may be joined together to form a fluorocycloalkyl ring of the formula:

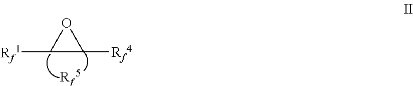

wherein each of R_{f}¹, and R_{f}⁴ are selected from a hydrogen atom, a fluorine atom or a fluoroalkyl group, R_{f}⁵ is a fluoroalkylene group of 2 to 5 carbon atoms, and the sum of the carbon atoms is 4 to 15. Preferably each of R_{f}¹ and R_{f}⁴ are selected from a fluorine atom or a perfluoroalkyl group. Optionally, R_{f}¹ and R_{f}⁴ contain one or more catenary (in-chain) heteroatoms, such as divalent oxygen or trivalent nitrogen bonded only to carbon atoms, such heteroatoms being a chemically stable link between perfluorocarbon portions of the perfluoroaliphatic group and which do not interfere with the inert character of the perfluoroaliphatic group. In preferred embodiments, R_{f}¹ and R_{f}⁴ are fluorine atoms or perfluoroalkyl groups. The skeletal chain of R_{f}¹ and R_{f}⁴ can be straight chain, branched chain, and if sufficiently large, cyclic, such as fluorocycloaliphatic groups, e.g. R_{f}⁵ as shown in Formula III. In some embodiments at least one of R_{f}¹ to R_{f}⁴ is a branched perfluoraliphatic group.

Preferred fluorooxiranes useful in the present invention include oxiranes which are fully fluorinated, i.e., all of the hydrogen atoms in the carbon backbone have been replaced with fluorine atoms. The carbon backbone can be linear, branched, or cyclic, or combinations thereof, and will preferably have about 4 to about 15 carbon atoms. Representative examples of perfluorooxirane compounds suitable for use in the processes and compositions of the invention include 2,3-difluoro-2,3-bis-trifluoromethyl-oxirane, 2,2,3-trifluoro-3-pentafluoroethyl-oxirane, 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, and oxiranes of HFP trimers, including 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane, 2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane.

Other oxiranes useful in the invention include fluorinated oxiranes with one to two hydrogen atoms. Representative examples include 2,3-bis-trifluoromethyl-oxirane, 2-pentafluoroethyl-3-trifluoromethyl-oxirane, 2-(1,2,2,2-tetrafluoro-1-trifluoromethyl-ethyl)-3-trifluoromethyl-oxirane, 2-nonafluorobutyl-3-pentafluoroethyl-oxirane, 2-fluoro-2-trifluoromethyl-oxirane, 2,2-bis-trifluoromethyl-oxirane, 2-fluoro-3-trifluoromethyl-oxirane, 2,3-difluoro-2-trifluoromethyl-oxirane, 2,2-difluoro-3-trifluoromethyl-oxirane, 2,3,3-trifluoro-2-difluoromethyl-oxirane and 3-fluoro-2,2-bis-trifluoromethyl-oxirane.

The R_{f} groups of the fluorooxiranes optionally contain one or more catenary (i.e. in-chain) heteroatoms interrupting the carbon backbone. Suitable heteroatoms include, for example, nitrogen and oxygen. Representative examples of such fluorooxiranes include 2-[difluoro-(2,3,3-trifluorooxiran-2-yl)methoxy]-1,1,2,2-tetrafluoro-N,N-bis(1,1,2,2,2-pentafluoroethyl)ethanamine, and 2-[difluoro(1,1,2,2,3,3,4,4,4-nonafluorobutoxy)methyl]-2,3,3-trifluoro-oxirane.

In addition to demonstrating dielectric gas performance, fluorooxiranes can offer additional important benefits in safety of use and in environmental properties. For example, 2,3-difluoro-2,3-bis-trifluoromethyl-oxirane, has low acute toxicity, based on short-term inhalation tests with rats exposed for four hours at a concentration of 50,000 ppm in air.

The fluorooxiranes are derived from fluorinated olefins that have been oxidized with epoxidizing agents. In the fluorooxirane compositions the carbon backbone includes the whole carbon framework including the longest hydrocarbon chain (main chain) and any carbon chains branching off of the main chain. In addition, there can be one or more catenated heteroatoms interrupting the carbon backbone such as oxygen, nitrogen, or sulfur atoms, for example ether or tertiary amine functionalities. The catenated heteroatoms are not directly bonded to the oxirane ring. In these cases the carbon backbone includes the heteroatoms and the carbon framework attached to the heteroatom.

The fluorooxirane compounds can be prepared by epoxidation of the corresponding fluorinated olefin using an oxidizing agent such as sodium hypochlorite, hydrogen peroxide or other well known epoxidizing agent such as peroxycarboxylic acids including metachloroperbenzoic acid or peracetic acid. The fluorinated olefinic precursors can be directly available as, for example, in the cases of 1,1,1,2,3,4,4,4-octafluoro-but-2-ene (for making 2,3-difluoro-2,3-bis-trifluoromethyl oxirane), 1,1,1,2,3,4,4,5,5,5-decafluoro-pent-2-ene (for making 2,3-difluoro-2-trifluoromethyl-3-pentafluoroethyl-oxirane) or 1,2,3,3,4,4,5,5,6 decafluoro-cyclohexene (for making 1,2,2,3,3,4,4,5,5,6-decafluoro-7-oxa-bicyclo[4.1.0]heptane). Other useful fluorinated olefinic precursors can include hexafluoropropene (HFP) oligomers and dimers and trimers of tetrafluoroethylene (TFE).

The HFP oligomers can be prepared by contacting 1,1,2,3,3,3-hexafluoro-1-propene (hexafluoropropene) with a catalyst or mixture of catalysts selected from the group consisting of alkali metal, quaternary ammonium, and quaternary phosphonium salts of cyanide, cyanate, and thiocyanate in the presence of polar, aprotic solvents such as, for example, acetonitrile. The preparation of these HFP oligomers is disclosed, for example, in U.S. Pat. No. 5,254,774 (Prokop). Useful oligomers include HFP trimers or HFP dimers. HFP dimers include a mixture of isomers of C₆F₁₂. HFP trimers include a mixture of isomers of C₉F₁₈.

The useful fluorooxiranes replacing SF₆ as a dielectric gas preferably have a gaseous range that encompasses the operating temperature range of the electrical device in which they are used as components of the gaseous dielectric of this invention, preferably such that the fluorooxiranes have a boiling point less than 60° C., more preferably below 30° C. and containing 3 to 9 carbon atoms. C₃ perfluorooxirane, i.e. the oxirane of hexafluoropropylene, may be excluded due to the known inhalation toxicity—having a 2.5 to 3 hour acute lethal concentration (ALC) of 200 ppm. Higher, i.e. greater than C₉, fluorooxiranes may be excluded for gaseous dielectric applications due to the low vapor pressure, under the operating conditions of most electrical devices, but are useful in applications requiring a liquid dielectric fluid.

Useful fluorooxirane gaseous dielectrics have a vapor pressure of at least 20 kPa, more preferably at least 40 kPa, at the operating temperature of the electrical device. Many electrical devices such as capacitors, transformers, circuit breakers and gas insulated transmission lines may operate at temperatures of at least 30° C. and above. In most embodiments, useful fluorooxiranes have a vapor pressure of at least 20 kPa at 25° C. Generally, useful fluorooxirane gaseous dielectrics have a boiling point in the range of −20 to 60° C., preferably −20 to 30° C. At these operating temperatures, the gaseous dielectrics desirably have a vapor pressure of at least 40 kPa.

Further, the fluorooxirane gaseous dielectrics preferably have a dielectric strength of at least 5 kV at their operating pressure in the electric device, which is typically at least 20 kPa. More preferably fluorooxiranes have a dielectric strength of at least 10 kV and most preferably at least 15 kV at the operating temperature and pressure of the device.

In some embodiments, the fluorooxirane gaseous dielectrics may be combined with a second conventional dielectric gas with higher pressure. These conventional dielectric gases have boiling points below 0° C., have a zero ozone depletion potential, a global warming potential below that of SF₆ (about 22,000), are chemically and thermally stable, and have a dielectric strength greater than air. The conventional dielectric gases include, for example, perfluoroalkanes with 1 to 4 carbon atoms. In some embodiments, the fluorooxirane may be combined with a second conventional non-condensable gas. The conventional non-condensable gases include nitrogen, helium, argon, and carbon dioxide. Generally, the second gas or gaseous dielectric is used in amounts such that vapor pressure is at least 70 kPa at 25° C., or at the operating temperature of the electrical device. In some embodiments the ratio of the vapor pressure of the second non-condensable dielectric gas to the fluorooxirane dielectric is at least 2.5:1, preferably at least 5:1, and more preferably at least 10:1.

The fluorooxiranes are useful in gaseous phase for electrical insulation and for arc quenching and current interruption equipment used in the transmission and distribution of electrical energy. Generally, there are three major types of electrical devices in which the gases of the present disclosure can be used: (1) gas-insulated circuit breakers and current-interruption equipment, (2) gas-insulated transmission lines, and (3) gas-insulated transformers. Such gas-insulated equipment is a major component of power transmission and distribution systems all over the world.

In some embodiments, the present disclosure provides electrical devices, such as capacitors, comprising metal electrodes spaced from each other such that the gaseous dielectric fills the space between the electrodes. The interior space of the electrical device may also comprise a reservoir of the liquid fluorooxirane which is in equilibrium with the gaseous fluorooxirane. Thus the reservoir may replenish any losses of the gaseous fluorooxirane.

For circuit breakers the thermal conductivity and dielectric strength of such gases, along with the thermal and dielectric recovery (short time constant for increase in resistivity), may provide for high interruption capability. These properties enable the gas to make a rapid transition between the conducting (arc plasma) and the dielectric state of the arc, and to withstand the rise of the recovery voltage.

For gas-insulated transformers the heat transfer performance, and compatibility with current devices, in addition to the dielectric characteristics, make them a desirable medium for use in this type of electrical equipment. The instant fluorooxiranes have distinct advantages over oil insulation, including having none of the fire safety problems or environmental compatibility issues and having, high reliability, little maintenance, long service life, low toxicity, ease of handling, and reduced equipment weight.

For gas-insulated transmission lines the dielectric strength of the gaseous fluorooxiranes under industrial conditions is significant, especially the behavior of the gaseous dielectric under metallic particle contamination, switching and lightning impulses, and fast transient electrical stresses. These gaseous fluorooxiranes may also have a high efficiency for transfer of heat from the conductor to the enclosure and are stable for long periods of time (e.g., 40 years). These gas-insulated transmission lines may offer distinct advantages: cost effectiveness, high-carrying capacity, low losses, availability at all voltage ratings, no fire risk, reliability, and a compact alternative to overhead high voltage transmission lines in congested areas that avoids public concerns with overhead transmission lines.

For gas-insulated substations, the entire substation (circuit breakers, disconnects, grounding switches, busbar, transformers, etc., are interconnected) is insulated with the gaseous dielectric medium of the present disclosure, and, thus, all of the above-mentioned properties of the dielectric gas are significant.

In some embodiments the gaseous dielectric may be present in an electric device as a gas per se, or as a gas in equilibrium with the liquid. In these embodiments the liquid phase serves as a reservoir for additional gaseous dielectric.

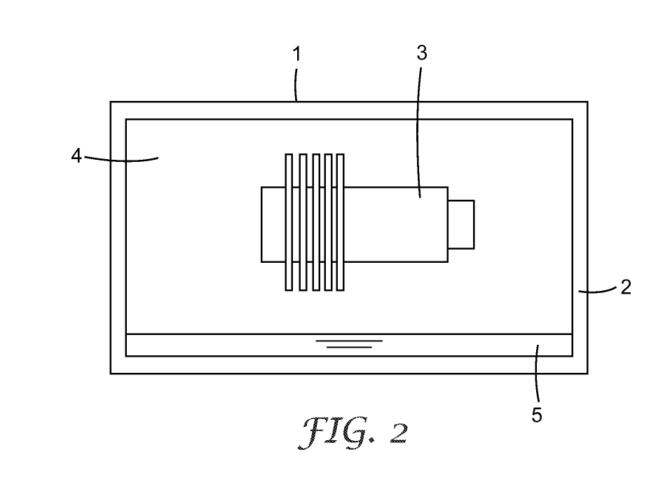

The use of fluorooxiranes as gaseous dielectrics is illustrated in the generic electrical device of FIG. 2. The Figure illustrates device comprising a tank or pressure vessel 2, containing electrical hardware 3, such as a switch, interrupter or the windings of a transformer, and at least one gaseous fluorooxirane 4. Optionally the gaseous fluorooxirane 4 is in equilibrium with a reservoir of a liquid fluorooxirane 5.

In another aspect, an electrical device is provided comprising, as the insulating material, the dielectric liquid comprising the fluorooxiranes. The dielectric liquids of the present invention may be useful in a number of other applications that use dielectric liquids. Examples of such other applications are described in U.S. Pat. No. 4,899,249 (Reilly et al.); U.S. Pat. No. 3,184,533 (Eiseman Jr.); UK Patent No. 1 242 180 (Siemens) and such descriptions are incorporated herein by reference.

Conventional dielectric liquids such as petroleum mineral oils have found wide application due to their low cost and ready availability. However, their use has been limited in many electrical devices because of their relative low chemical stability and their flammability. Chlorinated aromatic hydrocarbons, for example, polychlorinated biphenyls (PCBs), were developed as fire-resistant insulating liquids, have excellent chemical stability, and have a much lower dielectric constant than the mineral oils. Unfortunately, certain PCB isomers have a high resistance to biological degradation and problems of toxicity are now being encountered due to PCB spillage and leakage. A. C. M. Wilson, Insulating Liquids: Their Uses, Manufacture and Properties 6 (Peter Peregrinus Ltd 1980), notes the use of PCBs are likely to be phased out as other more environmentally safe liquids become available.

Advantageously, the fluorooxirane dielectric liquids have a high dielectrical strength, also described as high breakdown voltage. “Breakdown voltage,” as used in this application means the highest voltage applied to a liquid that induces arcing. Thus the dielectric liquids of the present invention can function under high voltages. The dielectric liquids of the present invention can also exhibit a low loss factor, that is, the amount of electrical energy that is lost as heat from an electrical device such as a capacitor.

The fluoroxirane dielectric liquids, when used as liquid dielectrics, have a liquid range that encompasses the operating temperature range of the electrical device in which they are used as components of the dielectric liquid of this invention, such that preferably the fluorooxiranes have a boiling range above 40° C. Typically, fluorooxirane dielectric liquids have a boiling range of about 40° C. to 260° C. or higher.

If desired, minor amounts (<50 wt. %) of perfluorinated liquids may be blended with the fluorooxiranes. The optional fluorinated, inert liquids can be one or a mixture of fluoroalkyl compounds having 5 to 18 carbon atoms or more, optionally, containing one or more catenary heteroatoms, such as divalent oxygen, hexavalent sulfur, or trivalent nitrogen and having a hydrogen content of less than 5% by weight, preferably less than 1% by weight.

Suitable fluorinated, inert liquids useful in this invention include, for example, perfluoroalkanes or perfluorocycloalkanes, such as, perfluoropentane, perfluorohexane, perfluoroheptane, perfluorooctane, perfluoro-1, 2-bis(trifluoromethyl)hexafluorocyclobutane, perfluorotetradecahydrophenanthrene, and perfluorodecalin; perfluoroamines, such as, perfluorotributyl amine, perfluorotriethyl amine, perfluorotriisopropyl amine, perfluorotriamyl amine, perfluoro-N-methyl morpholine, perfluoro-N-ethyl morpholine, and perfluoro-N-isopropyl morpholine; perfluoroethers, such as perfluorobutyl tetrahydrofuran, perfluorodibutyl ether, perfluorobutoxyethoxy formal, perfluorohexyl formal, and perfluorooctyl formal; perfluoropolyethers; hydrofluorocarbons, such as pentadecafluorohydroheptane, 1,1,2,2-tetrafluorocyclobutane, 1-trifluoromethyl-1,2,2-trifluorocyclobutane, 2-hydro-3-oxaheptadecafluorooctane.

In liquid-filled capacitors, it is advantageous to match the dielectric constant of the dielectric liquid with that of the dielectric film, that is, the dielectric constants of the two components should be approximately the same. In devices such as film-wound capacitors, the dielectric constant (Kₜₒₜₐₗ) of the device is a function of the following equation, wherein (dₜₒₜₐₗ) represents the total thickness of the dielectric film(s) and of the dielectric liquid layer(s).

dₜₒₜₐₗ/Kₜₒₜₐₗ=d_{film}/K_{film}+d_{fluid}/K_{fluid}

In view of the above equation, the dielectric constant of the device (Kₜₒₜₐₗ) is approximately that of the component having the lowest dielectric constant. For example, if the dielectric constant of the dielectric fluid is much lower than that of the dielectric film, the dielectric constant of the device is approximately that of the dielectric fluid. When the dielectric constant of the device is approximately that of the dielectric film, film breakdown and catastrophic failure of the capacitor can occur. Thus, it is desirable for the dielectric constant of the film and fluid to match, that is, be the same or be approximately the same.

The dielectric liquid can be matched to a dielectric film, even if an appropriate dielectric liquid is not commercially available. Furthermore, such a dielectric liquid displays other desirable properties such as nonflammability, dielectric strength, chemical stability, or surface tension.

Objects and advantages of this invention are further illustrated by the following examples, but the particular materials and amounts thereof recited in these examples, as well as other conditions and details, should not be construed to unduly limit this invention.

### EXAMPLES

TABLE 1
Materials

| Chemical | Description | Source |
|---|---|---|
| 2,3-difluoro-2,3,-bis- | C₄ Oxirane; C₄F₈O | Preparation 1 |
| trifluoromethyl-oxirane | | |
| 2,3-difluoro-2-(1,2,2,2- | C₆ Oxirane; C₆F₁₂O | Preparation 2 |
| tetrafluoro-1- | | |
| trifluoromethyl-ethyl)-3- | | |
| trifluoromethyl-oxirane | | |
| 1,2,2,3,3,4,4,5,5,6- | c-C₆ Oxirane; C₆F₁₀O | Preparation 3 |
| decafluoro-7-oxa- | | |
| bicyclo[4.1.0]heptane | | |
| 1,1,1,2,3,4,4,4-octafluoro- | 2 Isomers; | Zhejiang Juhua Co., |
| but-2-ene | 85% perfluoro-2-butene and 15% | LTD. Fluor-Polymeric Plant, |
| (Perfluoro-2-Butene) | perfluoro-1-butene | Zhejiang, China |
| 1,1,1,2,3,4,5,5,5- nonafluoro-4- trifluoromethyl-pent-2-ene (Perfluoro-4-methyl-2- Pentene) | 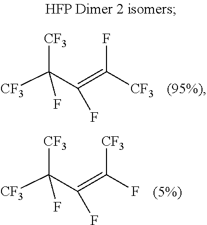 | 3M Foam Additive FA-188, 3M, St. Paul, MN |
| 1,2,3,3,4,4,5,5,6,6 decafluoro-cyclohexene (Perfluorocyclohexene) | 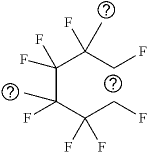 [SMILES: CC(F)(CF)C(F)(F)C(C)(F)C(F)(F)CF] | Available from Sigma- Aldrich, St. Louis, MO. |
| Sodium Hydroxide | NaOH | GFS Chemicals, Inc., |
| | | Powell, OH |
| Sodium Hypochlorite | Na⁺[ClO]⁻ | Alfa Aesar, Ward Hill, MA |
| Potassium Hydroxide | KOH | Sigma Aldrich, Milwaukee, |
| | | WI |
| Hydrogen Peroxide | H₂O₂ | GFS Chemicals, Inc., |
| | | Powell, OH |
| Acetonitrile | | Honeywell Burdick & |
| | | Jackson, Morristown, NJ |
| SF₆ | Sulfur Hexafluoride | Concorde Gas, Eatontown, |
| | | NJ |

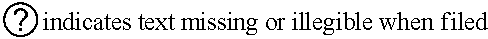

### Preparation 1: Synthesis and purification of 2,3-difluoro-2,3,-bis-trifluoromethyl-oxirane

In a 2-liter stainless steel reactor fitted with a mixer and a cooling jacket, 500 grams of acetonitrile, 700 grams of sodium hypochlorite (14% by weight concentration), and 100 grams of 50% by weight sodium hydroxide were added. Upon being sealed, the reactor temperature was controlled at 0° C. using the reactor cooling jacket. Then 200 grams of 1,1,1,2,3,4,4,4-octafluoro-but-2-ene was gradually added to the reactor under strong mixing while controlling the reactor temperature at 0° C. After all the perfluoro-2-butene was added within about 2 hours, the reactor was heated to 20° C. to allow the product crude to vent from the reactor overhead and to be captured by a dry ice trap connected to the reactor overhead. 160 grams of the product crude was collected in the dry ice trap. The product crude was then purified in a 40-tray Oldershaw fractionation column with condenser being cooled to −40° C. The fractionation column was operated in such a way so that the reflux ratio (the distillate flow rate going back to the fractionation column to the distillate flow rate going to the product collection cylinder) was at 10:1. The final product was collected as the condensate when the head temperature in the fractionation column was between 0° C. and 2° C.

The 100 grams of the final product collected from the method above was analyzed by 376.3 MHz ¹⁹F-NMR spectra and identified as 2,3-difluoro-2,3,-bis-trifluoromethyl-oxirane with a purity of 99.4%.

### Preparation 2: Synthesis of 2,3-difluoro-2-(1,2,2,2-tetrafluoro-1-trifluoromethyl-ethyl)-3-trifluoromethyl-oxirane

In a 1.5 liter glass reactor fitted with a mixer and a cooling jacket, 400 grams of acetonitrile, 200 grams of 1,1,1,2,3,4,5,5,5-nonafluoro-4-trifluoromethyl-pent-2-ene and 150 grams of 50% potassium hydroxide were added. The reactor temperature was controlled at 0° C. using the reactor cooling jacket. Then 100 grams of 50% hydrogen peroxide was slowly added to the reactor under strong mixing while controlling the reactor temperature at 0° C. After all the hydrogen peroxide was added within about 2 hours, the mixer was turned off to allow the product crude to phase split from solvent and aqueous phases. 155 grams of the product crude was collected from the bottom product phase. The product crude was then washed with 200 grams of water to remove solvent acetonitrile and then purified in a 40-tray Oldershaw fractionation column with condenser being cooled to 15° C. The fractionation column was operated in such a way so that the reflux ratio (the distillate flow rate going back to the fractionation column to the distillate flow rate going to the product collection cylinder) was at 10:1. The final product was collected as the condensate when the head temperature in the fractionation column was between 52° C. and 53° C.

The 90 grams of the final product collected from the method above was analyzed by 376.3 MHz ¹⁹F-NMR spectra and identified as a mixture of 2,3-difluoro-2-(1,2,2,2-tetrafluoro-1-trifluoro-methyl-ethyl)-3-trifluoromethyl-oxirane, 95.8% and 2.2% of 2-fluoro-2-pentafluoroethyl-3,3-bis-trifluoromethyl-oxirane.

### Preparation 3: Oxirane Synthesis and Purification of 1,2,2,3,3,4,4,5,5,6-decafluoro-7-oxa-bicyclo[4.1.0]heptane

In a 1.5 liter glass reactor fitted with a mixer and a cooling jacket, 400 grams of acetonitrile, 200 grams of 1,2,3,3,4,4,5,5,6,6-decafluoro-cyclohexene (89.3% purity) and 150 grams of 50% potassium hydroxide were added. The reactor temperature was controlled at 0° C. using the reactor cooling jacket. Then 100 grams of 50% hydrogen peroxide was slowly added to the reactor under strong mixing while controlling the reactor temperature at 0° C. After all the hydrogen peroxide was added within about 2 hours, the mixer was turned off to allow the product crude to phase split from solvent and aqueous phases. 100 grams of the product crude was collected from the bottom product phase. The product crude was then washed with 100 grams of water to remove solvent acetonitrile and then purified in a 40-tray Oldershaw fractionation column with condenser being cooled to 15° C. The fractionation column was operated in such a way that the reflux ratio (the distillate flow rate going back to the fractionation column to the distillate flow rate going to the product collection cylinder) was at 10:1. The final product was collected as the condensate when the head temperature in the fractionation column was between 47° C. and 55° C.

The 70 grams of the final product collected from the method above was analyzed by 376.3 MHz ¹⁹F-NMR spectra and identified as 1,2,2,3,3,4,4,5,5,6-decafluoro-7-oxa-bicyclo[4.1.0]heptane with a purity of 94.1% with an additional 2.6% isomers.

### Preparation 4

### Preparation of 2-[1,1,2,3,3,3-hexafluoro-2-(trifluoromethyl)propyl]-2-(trifluoromethyl)oxirane

### (CF₃)₂CFCF₂C(CF₃)OCH₂

In a 600 mL Parr reactor, hexafluoropropene dimer (300 g, 1.0 mol 3M Company), methanol (100 g, 3.12 mol, Aldrich) and TAPEH (t-amylperoxy-2-ethylhexanoate) (4 g, 0.017 mol) were charged. The reactor was sealed and the temperature was set to 75 deg. C. After stirring for 16 hours at temperature the reactor contents were emptied and washed with water to remove excess methanol. The fluorochemical phase that was recovered was dried over anhydrous magnesium sulfate and then filtered. This reaction was repeated two additional times to generate a total of 500 g of product (2,3,4,5,5,5-hexafluoro-2,4-bis(trifluoromethyl)pentan-1-ol). The crude reaction product was then purified by fractional distillation using a 15-tray Oldershaw column.

The fluorinated alcohol product, 2,3,4,5,5,5-hexafluoro-2,4-bis(trifluoromethyl)pentan-1-ol (257 g 0.77 mol) was charged to a 1 L round bottom flask equipped with magnetic stirring, cold water condenser, thermocouple (J-Kem controller) and an addition funnel. Thionyl chloride (202.25 g, 1.7 mol, Aldrich) was charged via the addition funnel to the fluorinated alcohol at room temperature. Once the addition was complete the temperature was increased to 85 deg. C. until no more offgas was observed. The water condenser was removed and a 1-plate distillation apparatus was put in place. The excess thionyl chloride was then distilled from the reaction mixture. 300 g of the product was collected. This product was charged to a flask containing 150 g of potassium fluoride in 500 mL of N-methyl-pyrrolidinone solvent. The reaction mixture was then stirred overnight at 35 deg. C. The following day the reaction flask was set up for distillation and the product 3,3,4,5,5,5-hexafluoro-2,4-bis(trifluoromethyl)pent-1-ene was distilled from the reaction flask. A total of 140 g was collected.

In a 500 mL jacketed reaction flask equipped with overhead stirring, cold water condenser, N2 bubbler and thermocouple, sodium hydroxide (2.5 g, 0.0636 mol, Aldrich), sodium hypochlorite (12% concentration 80 g, 0.127 mol), Aliquat 336 (1 g, Alfa-Aesar) were charged. The flask was cooled to 4 deg. C. The olefin, 3,3,4,5,5,5-hexafluoro-2,4-bis(trifluoromethyl)pent-1-ene (20 g 0.0636 mol) was charged to the mixture which was then stirred for 2 hours. After 2 hours, stirring was stopped and a lower FC phase was separated from the mixture. A total of 20 g of FC was collected. A sample of this was analyzed by ¹⁹F, ¹H and ¹³C NMR which confirmed the product structure for 2-[1,1,2,3,3,3-hexafluoro-2-(trifluoromethyl)propyl]-2-(trifluoromethyl)oxirane.

### Dielectric Strength (DS) Measurement

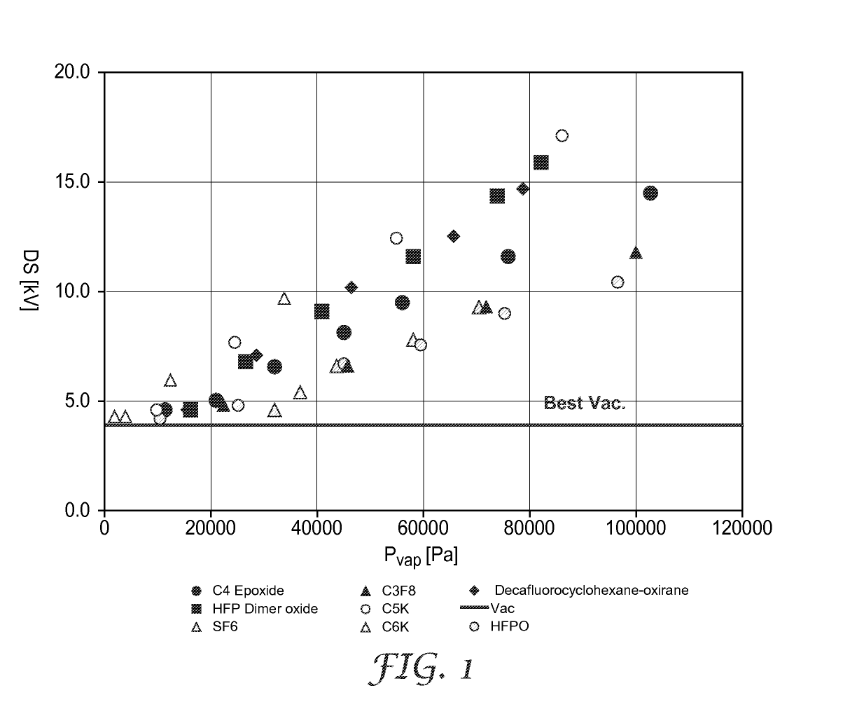

The gaseous dielectric strength of comparative SF₆, comparative C₃F₆O, comparative C₃F₈, C₄F₈O, C₆F₁₂O and c-C₆F₁₀O were measured experimentally using a dielectric Hipotronics OC90D dielectric strength tester (available from Hipotronics, Brewster, N.Y.) modified to allow low pressure gases. The electrode and test configuration comply with ASTM D877. The test chamber was first evacuated and the baseline dielectric strength was measured. Known quantities of SF₆, C₃F₆O, C₃F₈, C₄F₈O, C₆F₁₂O or c-C₆F₁₀O were then injected to achieve the measured pressure, Pᵥₐₚ. The dielectric strength (DS) was recorded after each injection. The results are shown in FIG. 1.

The shorter atmospheric lifetimes of the perfluorooxiranes lead to lower GWPs than SF₆. A measured IR cross-section was used to calculate the radiative forcing value for difluoro-2-(1,2,2,2-tetrafluoro-1-trifluoromethyl-ethyl)-3-trifluoromethyl-oxirane using the method of Pinnock, et al. (J. Geophys. Res., 100, 23227, 1995). Using this radiative forcing value and the experimentally determined atmospheric lifetime the GWP (100 year ITH) for 2,3-difluoro-2-(1,2,2,2-tetrafluoro-1-trifluoromethyl-ethyl)-3-trifluoromethyl-oxirane is less than that of SF₆.

1. An electrical device containing as a component a C₄ to C₁₅ fluorooxirane fluid dielectric, having two or fewer hydrogen atoms, said fluorooxirane of the formula: 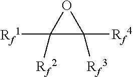
wherein each of R_{f}¹, R_{f}², R_{f}³ and R_{f}⁴ are selected from a hydrogen atom, a fluorine atom or a fluoroalkyl group, and the sum of the carbon atoms is 4 to 15, and any two of said R_{f} groups may be joined together to form a perfluorocycloalkyl ring.

2. The electrical device of claim 1 wherein the fluorooxirane is a perfluorooxirane.

3. The electrical device of claim 2 wherein the perfluorooxirane has a vapor pressure of at least 30 kPa at the operating temperature of the device.

4. (canceled)

5. The electrical device of claim 1 wherein the fluorooxirane is a C₄ to C₆ perfluorooxirane.

6. The electrical device of claim 1 wherein said fluorooxirane is a liquid dielectric at the operating temperature and pressure of the electrical device.

7. The electrical device of claim 1 comprising a fluorooxirane of the formula 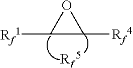
wherein each of R_{f}¹, and R_{f}⁴ are selected from a hydrogen atom, a fluorine atom or a fluoroalkyl group, and R_{f}⁵ is a fluoroalkylene group of 2 to 5 carbon atoms, and the sum of the carbon atoms is 4 to 15.

8. The fluid dielectric of claim 1 having a vapor pressure of at least 30 kPa at 25° C.

9. The fluid dielectric of claim 1 having a dielectric strength of at least 5 kV at 25 kPa.

10. The electrical device of claim 1 wherein the fluid dielectric has a global warming potential of less than 22,200.

11. The electrical device of claim 1 wherein the fluid dielectric further comprises a reservoir of liquid dielectric fluorooxirane.

12. The electrical device of claim 1 wherein at least one of R_{f}¹ or R_{f}² is (CF₃)₂CF—.

13. The electrical device of claim 1, wherein said electrical device is selected from the group consisting of: gas-insulated circuit breakers and current-interruption equipment, gas-insulated transmission lines, gas-insulated transformers, and gas-insulated substations.

14. The electrical device of claim 1 further comprising a second dielectric gas having a vapor pressure of at least 70 kPa.

15. The electrical device of claim 13 wherein the second dielectric gas is selected from nitrogen, helium, argon, and carbon dioxide or a perfluoroalkane.

16. A gaseous dielectric composition comprising a C4 to C7 perfluorooxirane gaseous dielectric, and a second gaseous dielectric comprising an inert gas having a vapor pressure is at least 70 kPa.

17. The gaseous dielectric composition of claim 16 wherein the ratio of the vapor pressure of the second gaseous dielectric to the perfluorooxirane dielectric is at least 2.5:1.

18. The gaseous dielectric composition of claim 17 wherein the inert gas is selected from nitrogen, helium, argon, and carbon dioxide.

19. The electrical device of claim 1 wherein the fluoroxirane dielectric is selected from 2,3-difluoro-2,3-bis-trifluoromethyl-oxirane, 2,2,3-trifluoro-3-pentafluoroethyl-oxirane, 2,3-difluoro-2-(1,2,2,2-tetrafluoro-1-trifluoromethyl-ethyl)-3-trifluoromethyl-oxirane, 2-fluoro-2-pentafluoroethyl-3,3-bis-trifluoromethyl-oxirane, 1,2,2,3,3,4,4,5,5,6-decafluoro-7-oxa-bicyclo[4.1.0]heptane, 2,3-difluoro-2-trifluoromethyl-3-pentafluoroethyl-oxirane, 2,3-difluoro-2-nonafluorobutyl-3-trifluoromethyl-oxirane, 2,3-difluoro-2-heptafluoropropyl-3-pentafluoroethyl-oxirane, 2-fluoro-3-pentafluoroethyl-2,3-bis-trifluoromethyl-oxirane, 2,3-bis-pentafluoroethyl-2,3-bistrifluoromethyl-oxirane, and oxiranes of HFP trimers, including 2-pentafluoroethyl-2-(1,2,2,2-tetrafluoro-1-trifluoromethyl-ethyl)-3,3-bis-trifluoromethyl-oxirane, 2-fluoro-3,3-bis-(1,2,2,2-tetrafluoro-1-trifluoromethyl-ethyl)-2-trifluoromethyl-oxirane, 2-fluoro-3-heptafluoropropyl-2-(1,2,2,2-tetrafluoro-1-trifluoromethyl-ethyl)-3-trifluoromethyl-oxirane and 2-(1,2,2,3,3,3-hexafluoro-1-trifluoromethyl-propyl)-2,3,3-tris-trifluoromethyl-oxirane.

20. The electrical device of claim 1 wherein the fluoroxirane dielectric is selected from 2,3-bis-trifluoromethyl-oxirane, 2-pentafluoroethyl-3-trifluoromethyl-oxirane, 2-(1,2,2,2-tetrafluoro-1-trifluoromethyl-ethyl)-3-trifluoromethyl-oxirane, 2-nonafluorobutyl-3-pentafluoroethyl-oxirane, 2-fluoro-2-trifluoromethyl-oxirane, 2,2-bis-trifluoromethyl-oxirane, 2-fluoro-3-trifluoromethyl-oxirane, 2,3-difluoro-2-trifluoromethyl-oxirane, 2,2-difluoro-3-trifluoromethyl-oxirane, 2,3,3-trifluoro-2-difluoromethyl-oxirane and 3-fluoro-2,2-bis-trifluoromethyl-oxirane.
